(19) United States
(12) Patent Application Publication
(10) Pub. No.: US 2025/0037181 A1
(43) Pub. Date: Jan. 30, 2025

(54) Ingredient Insight Device

(71) Applicants: Randy Robason, Dallas, TX (US); Tyler Freeman, Dallas, TX (US); Katherine Freeman, Dallas, TX (US)

(72) Inventors: Randy Robason, Dallas, TX (US); Tyler Freeman, Dallas, TX (US); Katherine Freeman, Dallas, TX (US)

(21) Appl. No.: 18/508,562

(22) Filed: Nov. 14, 2023

Related U.S. Application Data
(60) Provisional application No. 63/515,425, filed on Jul. 25, 2023.

(51) Int. Cl. G06Q 30/0601

(52) U.S. Cl. CPC G06Q 30/0627; G06K 7/1413

(57) ABSTRACT

An ingredient search application device is disclosed to identify ingredients that might impact a user's health and/or dietary concerns. The ingredient search application device comprises a software application that would be used on a smartphone or computer. A user would utilize the smartphone or computer to scan a product's ingredients. The scanned ingredients would be automatically searched on the Internet using existing technology. Further, the software application can scan a product's listed ingredients or its barcode to retrieve the information. Users can also simply type the product name in the search field to obtain the results.

### CROSS-REFERENCE TO RELATED APPLICATION

The present application claims priority to, and the benefit of, U.S. Provisional Application No. 63/515,425, which was filed on Jul. 25, 2023, and is incorporated herein by reference in its entirety.

### FIELD OF THE INVENTION

The present invention relates generally to the field of ingredient search application devices. More specifically, the present invention relates to an application that allows a user to scan a product with their smartphone to determine the potential impact of the product's ingredients on their health. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in ingredient search application devices. Currently, there does not appear to be any database that allows a user to scan the ingredients of a product and determine the potential impact of those ingredients on a user's health. It can also be difficult for expecting mothers to determine if a product could be harmful to their unborn child if they use it or consume it. This includes food products, skincare items, dyes, etc. A universal database that can be easily accessed with a quick scan is desirable.

Furthermore, reading food product labels and other general product labels to ensure they do not contain any harmful or unwanted ingredients can be a complex and time-consuming process. A user must read through dozens of ingredients and then search each individual ingredient to determine if that specific ingredient is harmful to the user's health and/or to their children's health. This can require large amounts of time spent at the grocery store, pharmacy, or other general merchandise retailer, etc., scouring ingredient lists and searching the health content of a wide variety of products based on their listed ingredients.

Accordingly, there is a demand for an improved ingredient search application device that allows a user to scan a product with their smartphone to determine the potential health issues with specific ingredients on its ingredient list. More particularly, there is a demand for an ingredient search application device that identifies harmful ingredients in a wide variety of products, such as food, shampoo, sunscreen, etc.

Therefore, there exists a long-felt need in the art for an ingredient search application device that allows users to scan a product with their smartphone to determine the potential impact of the product ingredients on a child's health. There is also a long-felt need in the art for an ingredient search application device that informs a pregnant mother that the product includes ingredients that could be harmful to her unborn child. Further, there is a long-felt need in the art for an ingredient search application device that identifies harmful ingredients in food, as well as in products like shampoo, sunscreen, etc. Moreover, there is a long-felt need in the art for a device that enables consumers to identify potentially problematic ingredients before a purchase is made. Further, there is a long-felt need in the art for an ingredient search application device that helps to prevent possible birth defects or long term health issues in children. Finally, there is a long-felt need in the art for an ingredient search application device that can utilize a product's barcode or scan a product's listed ingredients to retrieve the information.

The subject matter disclosed and claimed herein, in one embodiment thereof, comprises an ingredient search application device. The device is designed to identify ingredients that might impact a user, such as a mother or unborn child either during gestation or after birth by highlighting products with known negative health impacts, as well as those that simply have ‘red flags’ wherein the long term impact is currently unknown, but is suspect. The ingredient search application device comprises a software application that would be used on a smartphone or computer. A user would utilize the smartphone or computer to scan a product's ingredients. The scanned ingredients would be automatically searched on the Internet using existing technology. Further, the software application can scan a product's listed ingredients or its barcode to retrieve the information. Users can also simply type the product name in the search field to obtain the results.

In this manner, the ingredient search application device of the present invention accomplishes all of the foregoing objectives and provides users with a device that scans product ingredient lists and identifies harmful ingredients. The device enables consumers to identify potentially problematic ingredients before a purchase is made. The device can be utilized with a smartphone, tablet, or computer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ingredient search application device. The device is designed to identify ingredients that might impact a user, such as a mother or unborn child either during gestation or after birth by highlighting products with known negative health impacts, as well as those that simply have ‘red flags’ wherein the long term impact is currently unknown, but is suspect. The ingredient search application device comprises a software application that would be used on a smartphone or computer. A user would utilize the smartphone or computer to scan a product's ingredients. The scanned ingredients would be automatically searched on the Internet using existing technology. Further, the software application can scan a product's listed ingredients or its barcode to retrieve the information. Users can also simply type the product name in the search field to obtain the results.

In one embodiment, the ingredient search application device allows users multiple ways to interact with the device. Specifically, the device would allow various smart devices like computers, tablets, mobile phones, activity trackers, wearable devices, static terminals installed in the store location, and other handheld smart devices to scan item barcodes and/or nutrition labels and search the ingredient information on the Internet with on-line databases of ingredient information. In one example, the client interface (i.e., the smart device) maintains a connection to the Internet via the customer's Internet Service Provider (ISP) and/or by using the connection available at the store location. Further, the device includes smart devices as well as the software application that the users would use to access the device. The software application may be browser-based and may be accessed from desktops or kiosks, or application-based and accessed via handheld devices, such as smart watches, smartphones, tablets, activity trackers, wearable devices, etc., or any other suitable electronic device that has the required operating and memory parameters to support the software application of the present invention.

In one embodiment, the ingredient searching application device comprises a mobile computing device (i.e., smartphone, computers, tablets, wearable devices, activity trackers, etc.) comprising a software application for searching ingredients from products. The mobile or software application provides a secure website and/or smartphone application access by users for ingredient searches. In addition to these elements, the device of the present invention may also include a web server and Cloud database of ingredient identification and background data on the ingredients connectable to the mobile smartphone or portable tablet or computing device, etc.

In one embodiment of the invention, the ingredient information and data management software is maintained on a cloud server in a typical fashion. A secure cloud server is used for the protection and security of ingredient information, and information data stored on the cloud server. Thus, ingredient information, as well as identifying problematic ingredients, is sent to the cloud server and collected. Conveniently, the data is stored and managed with a data management software or program to manage the collected ingredient data.

Typically, a cellular wireless data network embedded in the computer, tablet, smartphone, etc., transmits both the product's ingredient list or scans the product's barcode. Once the ingredient list is identified, specific ingredients are searched for potential problematic ingredients via a Cloud data management server or other similar means.

In one embodiment, a user must first create an account and then log in or sign into the software application to get authenticated, before scanning items and utilizing the software application.

In one embodiment, once signed-in, the user interacts with the device via an Internet connection and the user's requests for service may be authenticated for security by a firewall system. The firewall system represents the set of security features provided at the server end of the device. This could be a set of hardware and/or software that may be, for example, manufactured, developed, and/or supported by a recognized third party. Further, a back-end node may act as the central repository for additional databases, which store information about the device in general. Once the requests have been authenticated by the Firewall system, they are received by the software application that, in one example, could be a cluster of web servers serving the application in collaboration with application servers and the backend central database system to perform all necessary processing. Once the requests have been processed, the software application proceeds with scanning the product's barcode and/or ingredient list.

In one embodiment the present invention may use scanning technologies to enable users to use text scanners and/or barcode scanners to obtain ingredient information about a potentially harmful substance and/or a substance that the customer chooses to avoid for health and/or other reasons found in a specified product. Further, users can also simply type the product name in the search field to obtain the ingredient list, as well. Additionally, the device is configured to analyze the received barcode or ingredient list to identify the potential problematic ingredients. For example, the device can be configured to use various image analysis techniques, natural language processing techniques, and cognitive analysis techniques in performing the functionality described herein. Such techniques can include, but are not limited to, optical character recognition (OCR), edge detection, neural networks, syntactic analysis, semantic analysis, sentiment analysis, word ranking techniques, regression algorithms, instance-based algorithms, decision tree algorithms, Bayesian algorithms, clustering algorithms, etc.

For example, visual recognition/image analysis techniques, such as those discussed above, can be used to identify a barcode of the product which can be used to identify the product and its ingredients from a database, accessed over the network. In yet other embodiments, image analysis, and natural language processing techniques can be used to analyze an image of the product's label which lists ingredients. Thus, the ingredients, in such embodiments, can be obtained without accessing a separate database over the network.

In one embodiment, after scanning a product's barcode or ingredient list, this information may then be uploaded to the Internet and/or compared against a database that is associated with a user's profile. Specifically, the user's profile can contain specific ingredients they wish to stay away from, allergies, and health issues, such as gluten or dairy-free, vegan, vegetarian, etc. Once created, a user's profile is temporarily stored in the process space of the software application, allowing the ingredient lists to be checked against the profile, as needed. The results are then sent back to the user.

In one embodiment, the client-side processes include the ingredient search application device, representing a client-side application that could be browser-based or stand-alone and used by tablets, mobile phones, and other small interactive devices with computing features and an in-built monitor and scanner.

In one embodiment, the server-side processes include a server-side component that receives data sent by the client-side into the server-side. The server-side includes the cluster of web servers serving the software application, the application server hosting components, and the backend database server hosting components, etc.

In one embodiment, an audible and/or visible alert may be sent to the user whenever a potentially hazardous ingredient is identified. This could be detected and sent from the server-side processes to the client-side processes.

In another embodiment, the present invention automatically performs the function of alerting consumers to harmful sub-ingredients that may not be specified clearly in the nutritional label.

In another embodiment, users/beneficiaries of the present invention may be: the allergy afflicted; individuals receiving prescription drugs; children (i.e., those whose physicians, neurologists, and/or other medical specialists advocate removal of certain ingredients from their diet as it is perceived to interfere with learning, i.e., gluten-free and a food coloring-free (Yellow #5 and Red #3); women who want to decrease the possibility of having a child with food allergies who are instructed by their doctor to refrain from consuming certain ingredients during their pregnancy; religious-observant (i.e., Kosher or Hindu); vegetarian; individuals with ingredient sensitivity (i.e., lactose intolerance or other ingredient sensitivity); individuals managing an illness and/or disease (i.e., such as individuals with digestive disorders and/or with chronic conditions which are aggravated by specific ingredients; children (i.e., those who may be receiving prescription medication for perceived learning disabilities who must refrain from certain OTC medications and/or food/beverage ingredients that may inhibit or suppress the effectiveness of the prescription or its duration), etc.

In another embodiment, an ingredient search application device is provided that permits a user to determine potential problematic/harmful ingredients in real-time, from any suitable product, such as, but not limited to, food, drugs, shampoo, sunscreen, baby products, makeup, etc., and other related products, before purchasing the products, as specified by their nutritional and/or ingredients labels. The device comprises any suitable scanning device, such as a barcode or text scanner for reading barcodes or text on the product's label and capturing the information by scanning the item(s); uploading the scanned information to a centralized or distributed database working with a single central repository or distributed repositories of product related information; mapping the information uploaded with lists of harmful ingredients and ingredient data; comparing this data with a user profile and analyzing ingredients that may be incompatible and/or cause allergic reactions and/or health risks; and generating an audible and/or text alert, which alert signals the presence of harmful ingredients or sub-ingredients within the product.

Thus, the present invention offers a solution to identifying problematic ingredients and focuses on finding products without any such ingredients. Thus, a product without any harmful ingredients can be easily and efficiently identified via the software application. Specifically, a user logs in or signs into the software application via their smartphone, tablet, or computer. Once signed in, the user scans a selected product barcode or ingredient list to identify a list of ingredients for the specified product. The software application, which is accessed via the smartphone, tablet or computer, etc., then searches the Internet, various databases, etc., for ingredient information based on the disclosed ingredient list. Once the search is complete, any potential problematic ingredients are identified and disclosed to the user. Further, optional text message notifications or other audio and/or visual alerts can be utilized to notify users of potentially problematic ingredients.

In yet another embodiment, the ingredient search application device comprises a plurality of indicia.

In yet another embodiment, a method of scanning products to identify potentially harmful ingredients is disclosed. The method includes the steps of providing an ingredient search application device comprising a software application that would be used on a user's smartphone, tablet, or computer. The method also comprises logging into the ingredient search application via a smartphone, tablet, or computer. Further, the method comprises scanning a product's barcode or ingredient list. Finally, the method comprises identifying potentially harmful ingredients in the products via the software application.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the ingredient search application device of the present invention showing a user in a grocery store with the device in accordance with the disclosed architecture;

FIG. 2 illustrates a perspective view of one embodiment of the ingredient search application device of the present invention showing the login screen of the software application in accordance with the disclosed architecture;

FIG. 3 illustrates a perspective view of one embodiment of the ingredient search application device of the present invention showing the various options for retrieving data from the software application in accordance with the disclosed architecture;

FIG. 4 illustrates a perspective view of one embodiment of the ingredient search application device of the present invention showing the barcode being scanned by the device in accordance with the disclosed architecture;

FIG. 5 illustrates a perspective view of one embodiment of the ingredient search application device of the present invention showing a harmful ingredient highlighted in accordance with the disclosed architecture;

FIG. 6 illustrates a flowchart showing the method of scanning products to identify potentially harmful ingredients in accordance with the disclosed architecture;

FIG. 7 is a schematic diagram illustrating one embodiment of the ingredient search application device of the present invention in accordance with the disclosed architecture; and

FIG. 8 illustrates an exemplary user device that is used for installing the software application for identifying harmful ingredients from products of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an ingredient search application device that allows users to scan a product with their smartphone to determine the potential impact of the product ingredients on a child's health. There is also a long-felt need in the art for an ingredient search application device that informs a pregnant mother that the product includes ingredients that could be harmful to her unborn child. Further, there is a long-felt need in the art for an ingredient search application device that identifies harmful ingredients in food, as well as in products like shampoo, sunscreen, etc. Moreover, there is a long-felt need in the art for a device that enables consumers to identify potentially problematic ingredients before a purchase is made. Further, there is a long-felt need in the art for an ingredient search application device that helps to prevent possible birth defects or long term health issues in children. Finally, there is a long-felt need in the art for an ingredient search application device that can utilize a product's barcode or scan a product's listed ingredients to retrieve the information.

The present invention, in one exemplary embodiment, is a novel ingredient search application device. The device is designed to identify ingredients that might impact the health and/or nutrition of a user. The ingredient search application device comprises a software application that would be used on a smartphone or computer. A user would utilize the smartphone or computer to scan a product's ingredients. The scanned ingredients would be automatically searched on the Internet using existing technology. Further, the software application can scan a product's listed ingredients or its barcode to retrieve the information. Users can also simply type the product name in the search field to obtain the results. The present invention also includes a novel method of scanning products to identify potentially harmful ingredients. The method includes the steps of providing an ingredient search application device comprising a software application that would be used on a user's smartphone, tablet, or computer. The method also comprises logging into the ingredient search application via a smartphone, tablet, or computer. Further, the method comprises scanning a product's barcode or ingredient list. Finally, the method comprises identifying potentially harmful ingredients in the products via the software application.

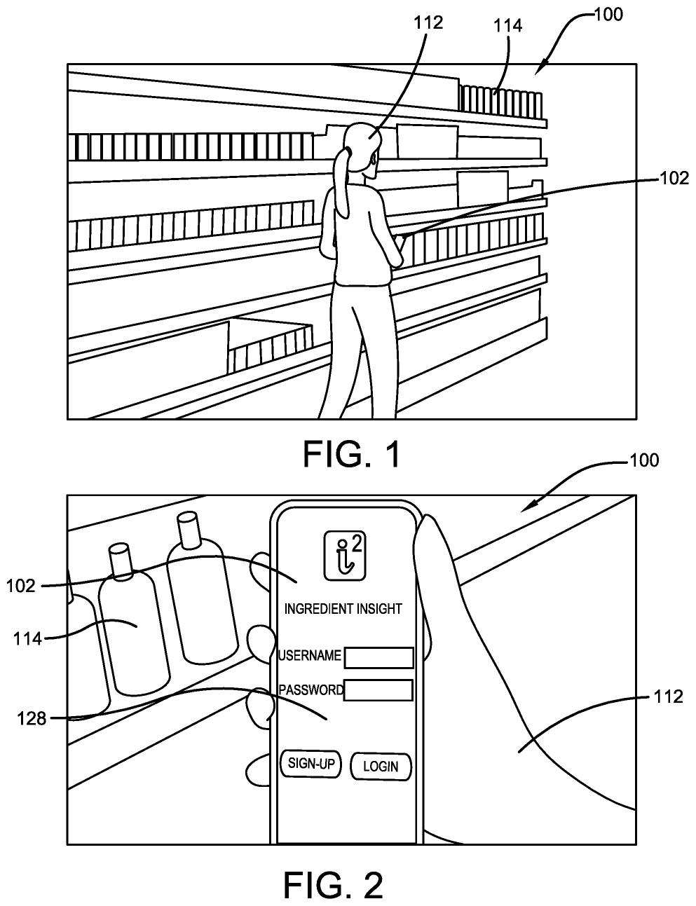

Referring initially to the drawings, FIG. 1 illustrates a perspective view of one embodiment of the ingredient search application device 100 of the present invention. In the present embodiment, the ingredient search application device 100 is an improved ingredient search application device 100 that provides a user 112 with a means for identifying potentially hazardous ingredients within a product 114. Specifically, the ingredient search application device 100 comprises a software application that is used on a user device 102. A user 112 would utilize the user device 102 to scan a product's ingredients 116. The scanned ingredients 116 would be automatically searched on the Internet using existing technology. Further, the software application can scan a product's listed ingredients 116 or its barcode 118 to retrieve the information. Users 112 can also simply manually type the product name in the search field 120 to obtain the results.

Generally, an ingredient search application device 100 is provided that permits a user 112 to determine potential problematic/harmful ingredients 122 in real-time, from any suitable product 114, such as, but not limited to, health products, food, drugs, shampoo, sunscreen, baby products, makeup, laundry, products, cleaning products, etc., and any other related products, before purchasing the products 114, as specified by their nutritional and/or ingredients labels 124. The device 100 comprises any suitable scanning user device 102, such as a barcode or text scanner for reading barcodes 118 or text on the product's label 124 and capturing the information by scanning the item(s); uploading the scanned information to a centralized or distributed database 110 working with a single central repository or distributed repositories of product related information; mapping the information uploaded with lists of harmful ingredients 122 and ingredient data; comparing this data with a user profile and analyzing ingredients 116 that may be incompatible and/or cause allergic reactions and/or health risks; and generating an audible and/or text alert 126, which alert 126 signals the presence of harmful ingredients 122 or sub-ingredients within the product 114.

Typically, users 112/beneficiaries of the present invention may be: the allergy afflicted; individuals receiving prescription drugs; children (i.e., those whose physicians, neurologists, and/or other medical specialists advocate removal of certain ingredients from their diet as it is perceived to interfere with learning, i.e., gluten-free and a food coloring-free (Yellow #5 and Red #3); women who want to decrease the possibility of having a child with food allergies who are instructed by their doctor to refrain from consuming certain ingredients during their pregnancy; religious-observant (i.e., Kosher or Hindu); vegetarian; individuals with ingredient sensitivity (i.e., lactose intolerance or other ingredient sensitivity); individuals managing an illness and/or disease (i.e., such as individuals with digestive disorders and/or with chronic conditions which are aggravated by specific ingredients; children (i.e., those who may be receiving prescription medication for perceived learning disabilities who must refrain from certain OTC medications and/or food/beverage ingredients that may inhibit or suppress the effectiveness of the prescription or its duration), etc., or any other suitable user 112 who is concerned about the use of potentially harmful ingredients 122 in their products 114.

As shown in FIG. 2, the ingredient search application device 100 allows users 112 multiple ways to interact with the device 100. Specifically, the device 100 would allow various smart devices 102 like computers, tablets, mobile phones, activity trackers, wearable devices, static terminals installed in the store location, and other handheld smart devices to scan item barcodes 118 and/or nutrition labels 124 and search the ingredient 116 information on the Internet with on-line databases 110 of ingredient information. In one example, the client interface (i.e., the smart device 102) maintains a connection to the Internet via the customer's Internet Service Provider (ISP) and/or by using the connection available at the store location. Further, the device 100 includes smart devices 102 as well as the software application that the users 112 would use to access the device 100. The software application may be browser-based and may be accessed from desktops or kiosks, or application-based and accessed via handheld devices, such as smart watches, smartphones, tablets, activity trackers, wearable devices, etc., or any other suitable electronic device that has the required operating and memory parameters to support the software application of the present invention.

Further, the ingredient searching application device 100 comprises a mobile computing device 102 (i.e., smartphone, computers, tablets, wearable devices, activity trackers, etc.) comprising a software application for searching ingredients 116 from products 114. The mobile or software application provides a secure website and/or smartphone application access by users 112 for ingredient 116 searches. In addition to these elements, the device 100 of the present invention may also include a web server and Cloud database of ingredient identification and background data on the ingredients 116 connectable to the mobile smartphone or portable tablet or computing device, etc. (102).

Generally, the ingredient information and data management software is maintained on a cloud server in a typical fashion. A secure cloud server is used for the protection and security of ingredient information, and information data stored on the cloud server. Thus, ingredient information, as well as identifying problematic ingredients, is sent to the cloud server and collected. Conveniently, the data is stored and managed with a data management software or program to manage the collected ingredient data.

Typically, a cellular wireless data network embedded in the computer, tablet or smartphone, etc. (102), transmits both the product's ingredient list 116 or scans the product's barcode 118. Once the ingredient list 116 is identified, specific ingredients 116 are searched for potential problematic ingredients 122 via a Cloud data management server or other similar means.

Generally, a user 112 must first create an account and then log in or sign into the software application via the user interface 128 to get authenticated, before scanning items and utilizing the software application.

Once signed in, the user 112 interacts with the device 100 via an Internet connection and the user's requests for service may be authenticated for security by a firewall system. The firewall system represents the set of security features provided at the server end of the device 100. This could be a set of hardware and/or software that may be, for example, manufactured, developed, and/or supported by a recognized third party. Further, a back-end node may act as the central repository for additional databases, which store information about the device 100 in general. Once the requests have been authenticated by the Firewall system, they are received by the software application that, in one example, could be a cluster of web servers serving the application in collaboration with application servers and the backend central database system to perform all necessary processing. Once the requests have been processed, the software application proceeds with scanning the product's barcode 118 and/or ingredient list 116 or manually using the search field 120.

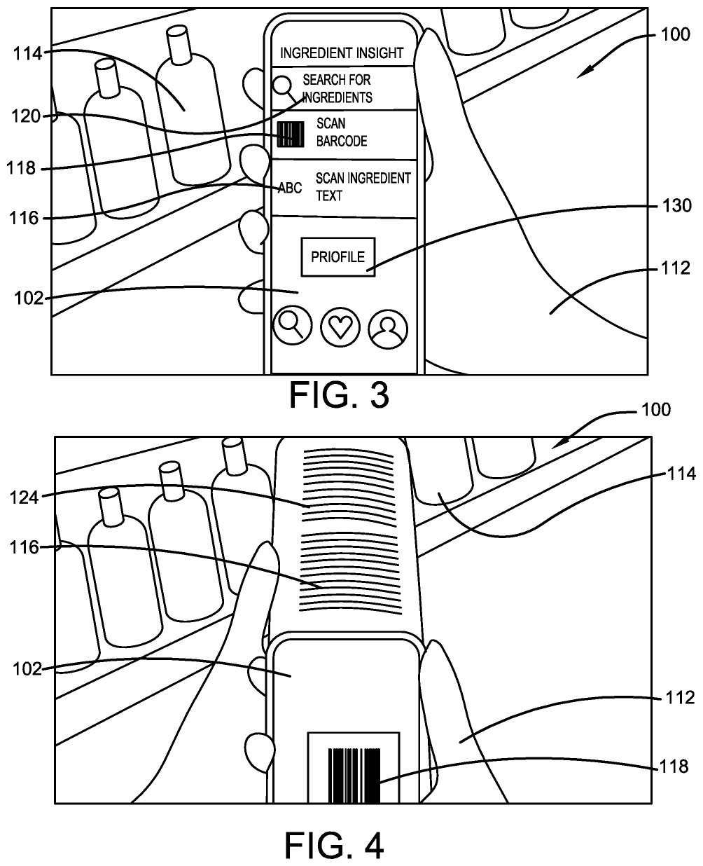

As shown in FIGS. 3-4, the present invention may use scanning technologies to enable users 112 to use text scanners and/or barcode scanners to obtain ingredient information about a potentially harmful ingredient 122 and/or an ingredient that the user 112 chooses to avoid for health and/or other reasons found in a specified product 114. Further, users 112 can also simply type the product name in the search field 120 to obtain the ingredient list 116, as well. Additionally, the device 100 is configured to analyze the received barcode 118 or ingredient list 116 to identify the potential problematic ingredients. For example, the device 100 can be configured to use various image analysis techniques, natural language processing techniques, and cognitive analysis techniques in performing the functionality described herein. Such techniques can include, but are not limited to, optical character recognition (OCR), edge detection, neural networks, syntactic analysis, semantic analysis, sentiment analysis, word ranking techniques, regression algorithms, instance-based algorithms, decision tree algorithms, Bayesian algorithms, clustering algorithms, etc.

For example, visual recognition/image analysis techniques, such as those discussed above, can be used to identify a barcode 118 of the product 114 which can be used to identify the product 114 and its ingredients 116 from a database 110, accessed over the network. In yet other embodiments, image analysis, and natural language processing techniques can be used to analyze an image of the product's label 124 which lists ingredients 116. Thus, the ingredients 116, in such embodiments, can be obtained without accessing a separate database over the network.

After scanning a product's barcode 118 or ingredient list 116, this information may then be uploaded to the Internet and/or compared against a database that is associated with a user's profile 130. Specifically, the user's profile 130 can contain specific ingredients 116 they wish to stay away from, allergies, health issues, such as gluten or dairy-free, vegan, vegetarian, etc. Once created, a user's profile 130 is temporarily stored in the process space of the software application, allowing the ingredient lists 116 to be checked against the profile 130, as needed. The results are then sent back to the user 112.

In one embodiment, the client-side processes include the ingredient search application device 100, representing a client-side application that could be browser-based or stand-alone and used by tablets, mobile phones and other small interactive devices 102 with computing features and an in-built monitor and scanner.

In one embodiment, the server-side processes include a server-side component that receives data sent by the client-side into the server-side. The server-side includes the cluster of web servers serving the software application, the application server hosting components and the backend database server hosting components, etc.

As shown in FIG. 5, an audible and/or visible alert 126 may be sent to the user 112 whenever a potentially hazardous ingredient 122 is identified. This could be detected and sent from the server-side processes to the client-side processes. The audible and/or visible alert 126 can be any suitable alert, such as, but not limited to, an alarm, a beep, a ringtone, a text, a flashing light, a vibration, etc.

In one embodiment, the present invention automatically performs the function of alerting users 112 to harmful sub-ingredients that may not be specified clearly in the nutritional label 124.

In yet another embodiment, the ingredient search application device 100 comprises a plurality of indicia 132. Specifically, the software application of the device 100 may include advertising, a trademark, or other letters, designs, or characters, printed, painted, stamped, or integrated into the software application, or any other indicia 132 as is known in the art. Specifically, any suitable indicia 132 as is known in the art can be included, such as, but not limited to, patterns, logos, emblems, images, symbols, designs, letters, words, characters, animals, advertisements, brands, etc., that may or may not be food product, baby product, or brand related.

Thus, the present invention offers a solution to identifying problematic ingredients 122 and focuses on finding products 114 without any such ingredients. Thus, a product 114 without any harmful ingredients 122 can be easily and efficiently identified via the software application. Specifically, a user 112 logs in or signs into the software application via the user interface 128 on their smartphone, tablet, or computer 102. Once signed-in, the user 112 scans a selected product barcode 118 or ingredient list 116 to identify a list of ingredients 116 for the specified product 114. The software application, which is accessed via the smartphone, tablet, or computer, etc. (102), then searches the Internet, various databases, etc., for ingredient information based on the disclosed ingredient list 116. Once the search is complete, any potential problematic ingredients 122 are identified and disclosed to the user 122. Further, optional text message notifications or other audio and/or visual alerts 126 can be utilized to notify users 112 of potentially problematic ingredients 122.

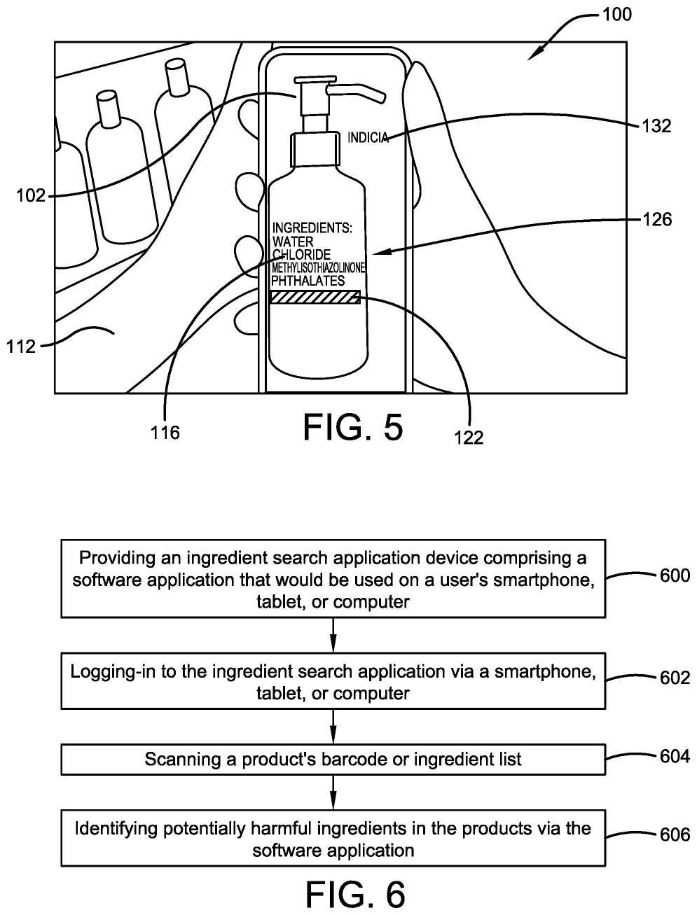

FIG. 6 illustrates a flowchart of the method of scanning products to identify potentially harmful ingredients. The method includes the steps of at 600, providing an ingredient search application device comprising a software application that would be used on a user's smartphone, tablet, or computer. The method also comprises at 602, logging-in to the ingredient search application via a smartphone, tablet, or computer. Further, the method comprises at 604, scanning a product's barcode or ingredient list. Finally, the method comprises at 606, identifying potentially harmful ingredients in the products via the software application.

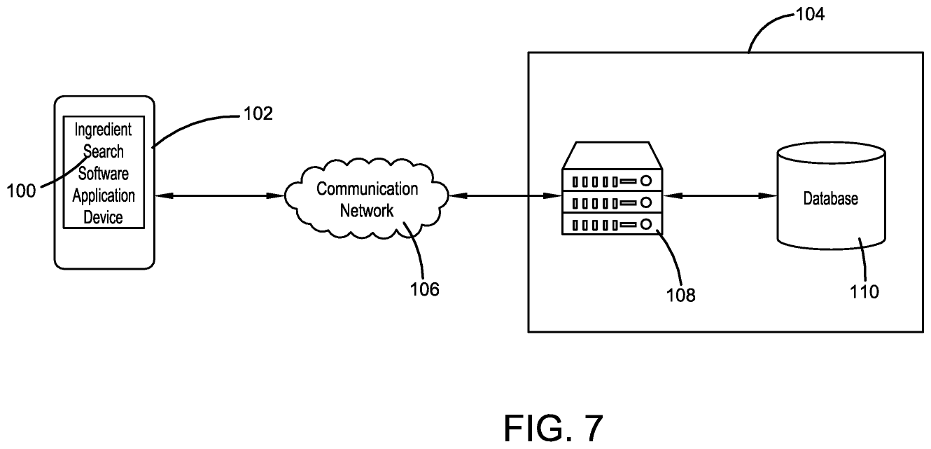

FIG. 7 is a schematic diagram illustrating one embodiment of the ingredient search application device 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smart-phone, an activity tracker, a wearable device, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, minicomputers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web framework, a .NET framework, a personal home page (PHP) framework, or any web application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the application 100, as well as ingredient identification and its potential harmfulness. In some embodiments, a set of centralized or distributed networks of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address), and the physical address may be a Media Access Control (MAC) address. The communication network 106 may be associated with an application layer for the implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, or a combination of wireless and wired channels thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

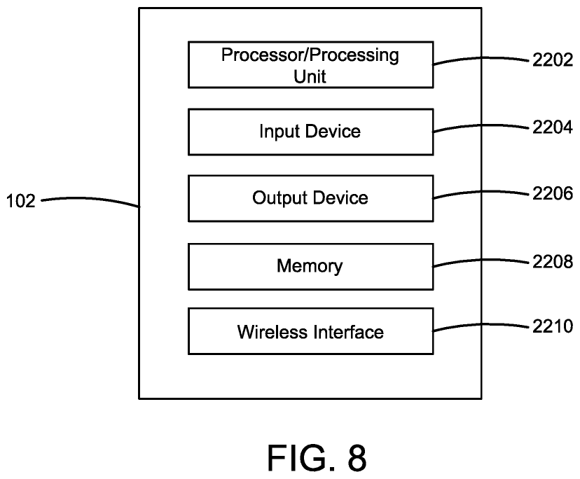

FIG. 8 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic user device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot, and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, activity trackers, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “ingredient search application device”, “application device”, “search device”, and “device” are interchangeable and refer to the ingredient search application device 100 of the present invention.

Notwithstanding the foregoing, the ingredient search application device 100 of the present invention can be of any suitable size and configuration as is known in the art without affecting the overall concept of the invention, provided that it accomplishes the above-stated objectives. One of ordinary skill in the art will appreciate that the ingredient search application device 100 as shown in FIGS. 1-8 is for illustrative purposes only, and many other sizes and shapes of the ingredient search application device 100 are well within the scope of the present disclosure. Although the dimensions of the ingredient search application device 100 are important design parameters for user convenience, the ingredient search application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ingredient search application device that identifies potentially harmful ingredients within a product, the ingredient search application device comprising:
a software application; and
a user device;
wherein the software application is accessible on the user device;
wherein a user would scan a product via the user device to determine a list of ingredients; and
further wherein the user would then search the list of ingredients via Internet to determine if there are any harmful ingredients among the list of ingredients.

2. The ingredient search application device of claim 1, wherein the product includes health products, food, drugs, shampoo, sunscreen, baby products, makeup, laundry products, or cleaning products.

3. The ingredient search application device of claim 2, wherein the user device is a computer, a laptop, a tablet, a smartphone, an activity tracker, a wearable device, or a static terminal installed in a store location.

4. The ingredient search application device of claim 3, wherein the user device maintains a connection to the Internet via a user's Internet Service Provider (ISP) or by using a connection available at a store location.

5. The ingredient search application device of claim 4, wherein the software application is either browser-based and may be accessed from desktops or terminals, or application-based and accessed via handheld user devices.

6. The ingredient search application device of claim 5 further comprising a web server and a Cloud database of ingredient identification and background data on the ingredients connectable to the user device.

7. The ingredient search application device of claim 6, wherein the ingredient information and data management software is maintained on a secure cloud server, wherein the secure cloud server is used for protection and security of the ingredient information and information data, and wherein data is stored and managed with a data management software program to manage collected ingredient data.

8. The ingredient search application device of claim 7, wherein users log into the software application via a user interface on the user device.

9. The ingredient search application device of claim 8, wherein the user scans the product via the user device to determine the list of ingredients by scanning a product's barcode, scanning an ingredient list on a product label, or manually using a search field.

10. The ingredient search application device of claim 9, wherein the user can create a user profile containing specific ingredients they wish to stay away from, allergies, or health issues.

11. The ingredient search application device of claim 10, wherein once created, the user profile is temporarily stored in a process space of the software application, allowing the scanned ingredient lists to be checked against the user profile, as needed.

12. The ingredient search application device of claim 11, wherein an audible or visible alert is sent to the user whenever a harmful ingredient is identified.

13. An ingredient search application device that identifies potentially harmful ingredients within a product, the ingredient search application device comprising:
a software application; and
a user device for scanning barcodes or text on a product label and capturing ingredient information from the product label;
wherein the user device is a computer, a laptop, a tablet, a smartphone, an activity tracker, a wearable device, or a static terminal installed in a store location;
wherein the software application is either browser-based and may be accessed from desktops or terminals, or application-based and accessed via handheld user devices;
wherein the user scans the product via the user device to determine the list of ingredients by scanning a product's barcode, scanning an ingredient list on a product label, or manually using a search field;
wherein scanned information is uploaded to a centralized or distributed database working with a single central repository or distributed repositories of product related information;
wherein the scanned information is mapped and uploaded with lists of harmful ingredients and ingredient data;
wherein this data is compared with a user profile and the ingredients are analyzed for health risks; and
further wherein an audible or text alert is generated to signal presence of harmful ingredients within the product.

14. The ingredient search application device of claim 13, wherein the product includes health products, food, drugs, shampoo, sunscreen, baby products, makeup, laundry products, or cleaning products.

15. The ingredient search application device of claim 13, wherein the user device maintains a connection to Internet via a user's Internet Service Provider (ISP) or by using a connection available at a store location.

16. The ingredient search application device of claim 13 further comprising a web server and a Cloud database of ingredient identification and background data on the ingredients connectable to the user device.

17. The ingredient search application device of claim 16, wherein the ingredient information and data management software is maintained on a secure cloud server, wherein the secure cloud server is used for protection and security of the ingredient information and information data, and wherein data is stored and managed with a data management software program to manage collected ingredient data.

18. The ingredient search application device of claim 13, wherein users log into the software application via a user interface on the user device.

19. The ingredient search application device of claim 13 further comprises a plurality of indicia.

20. A method of scanning products to identify potentially harmful ingredients, the method comprising the following steps:
providing an ingredient search application device comprising a software application that would be used on a user's smartphone, tablet, or computer;
logging-in to the ingredient search application via a smartphone, tablet, or computer;
scanning a product's barcode or ingredient list; and
identifying potentially harmful ingredients in the products via the software application.
